(19) United States
(12) Patent Application Publication
(10) Pub. No.: US 2026/0270991 A1
(43) Pub. Date: Sep. 10, 2026

(54) METHODS, DEVICES, AND MEDIUM FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 18/876,933

(22) PCT Filed: Jun. 22, 2022
(86) PCT No.: PCT/CN2022/100525

§ 371 Date: Dec. 19, 2024

(51) Int. Cl. H04W 72/1273; H04L 1/1812; H04W 72/232

(52) U.S. Cl. CPC H04W 72/1273; H04L 1/1812; H04W 72/232

(57) ABSTRACT

Example embodiments of the present disclosure relate to methods, devices, and computer storage medium for communication. A terminal device receives, from a network device, a DCI scheduling multiple PDSCHs on multiple cells; determines, from the multiple cells, a reference cell for generating a HARQ-ACK codebook comprising multiple bit groups corresponding to the multiple cells; generates the HARQ-ACK codebook by determining, in a first bit group for a first cell of the multiple cells, a first bit position for a first PDSCH on the first cell, based on a reference bit position for a reference PDSCH on the reference cell in a reference bit group for the reference cell, the first PDSCH and the reference PDSCH having a TDRA row index; and transmits the HARQ-ACK codebook to the network device. As such, the length of bits in a HARQ-ACK codebook in a slot may be determined based on a reference cell when MC-DCI is applied. Accordingly, the proceeding complexity for generating the HARQ-ACK codebook may be reduced.

### FIELD

Example embodiments of the present disclosure generally relate to the field of communication techniques and in particular, to methods, devices, and a computer readable medium for communication.

### BACKGROUND

To improve transmission reliability, a hybrid automatic repeat request (HARQ) mechanism has been widely used in communication systems. According to the HARQ mechanism, a receiver transmits HARQ feedback information to a transmitter to indicate whether a data transmission from the transmitter is detected successfully.

In release 15, downlink control information (DCI) on a physical downlink control channel (PDCCH) may be used to schedule a physical downlink shared channel (PDSCH) on a serving cell. In release 17, the DCI is enhanced to schedule multiple PDSCHs in different slots in time domain on the serving cell. A HARQ codebook may be used for HARQ feedback information of the PDSCH(s) on the serving cell.

It is proposed to further enhance DCI to schedule multiple PDSCHs on multiple cells. However, how to transmit the HARQ feedback information for multiple PDSCHs on multiple cells is needed to be discussed.

### SUMMARY

In general, example embodiments of the present disclosure provide methods, devices and a computer storage medium for communication.

In a first aspect, there is provided a method of communication. The method comprises: receiving, at a terminal device from a network device, a DCI scheduling a plurality of PDSCHs on a plurality of cells, one or more of the plurality of PDSCHs being scheduled for a cell of the plurality of cells; determining, from the plurality of cells, a reference cell for generating a hybrid automatic repeat request (HARQ)-acknowledgement (ACK) codebook for the plurality of PDSCHs, the HARQ-ACK codebook comprising a plurality of bit groups corresponding to the plurality of cells; generating the HARQ-ACK codebook by determining, in a first bit group for a first cell of the plurality of cells, a first bit position for a first PDSCH on the first cell, based on a reference bit position for a reference PDSCH on the reference cell in a reference bit group for the reference cell, the first PDSCH and the reference PDSCH having a same time domain resource allocation (TDRA) row index; and transmitting the HARQ-ACK codebook to the network device.

In a second aspect, there is provided a method of communication. The method comprises: receiving, at a terminal device from a network device, a DCI scheduling a plurality of PDSCHs on a plurality of cells, one or more of the plurality of PDSCHs being scheduled for a cell of the plurality of cells; determining a plurality of subsets of slot offset values, each slot offset value indicating a gap between a slot of one of the plurality of PDSCHs and a slot of a HARQ-ACK codebook; determining a plurality of merged TDRA tables based on the plurality of subsets; generating the HARQ-ACK codebook based on the plurality of subsets and the plurality of merged TDRA tables; and transmitting the HARQ-ACK codebook to the network device.

In a third aspect, there is provided a method of communication. The method comprises: receiving, at a terminal device from a network device, a DCI scheduling a plurality of PDSCHs on a plurality of cells, one or more of the plurality of PDSCHs being scheduled for a cell of the plurality of cells; determining, from the plurality of cells, a reference cell for generating a HARQ-ACK codebook for the plurality of PDSCHs; generating the HARQ-ACK codebook comprising bits in an increasing order of a PDSCH reception starting time on the reference cell; and transmitting the HARQ-ACK codebook to the network device.

In a fourth aspect, there is provided a method of communication. The method comprises: transmitting, at a network device to a terminal device, a DCI scheduling a plurality of PDSCHs on a plurality of cells, one or more of the plurality of PDSCHs being scheduled for a cell of the plurality of cells; and receiving, from the terminal device, a HARQ-ACK codebook for the plurality of PDSCHs, the HARQ-ACK codebook comprising a plurality of bit groups corresponding to the plurality of cells, where a first bit position in a first bit group for a first PDSCH on a first cell of the plurality of cells is based on a reference bit position for a reference PDSCH on a reference cell in a reference bit group for the reference cell, the first PDSCH and the reference PDSCH having a same time domain resource allocation (TDRA) row index.

In a fifth aspect, there is provided a method of communication. The method comprises: transmitting, at a network device to a terminal device, a DCI scheduling a plurality of PDSCHs on a plurality of cells, one or more of the plurality of PDSCHs being scheduled for a cell of the plurality of cells; and receiving, from the terminal device, a HARQ-ACK codebook for the plurality of PDSCHs based on a plurality of subsets of slot offset values and a plurality of merged TDRA tables, where the plurality of merged TDRA tables are determined based on the plurality of subsets, and where each slot offset value is used to indicate a gap between a slot of one of the plurality of PDSCHs and a slot of the HARQ-ACK codebook.

In a sixth aspect, there is provided a method of communication. The method comprises: transmitting, at a network device to a terminal device, a DCI scheduling a plurality of PDSCHs on a plurality of cells, one or more of the plurality of PDSCHs being scheduled for a cell of the plurality of cells; receiving, from the terminal device, a HARQ-ACK codebook for the plurality of PDSCHs, the HARQ-ACK codebook comprising bits in an increasing order of PDSCH reception starting time of a reference cell.

In a seventh aspect, there is provided a terminal device. The terminal device comprises a processor and a memory. The memory is coupled to the processor and stores instructions thereon. The instructions, when executed by the processor, cause the terminal device to perform the method according to the first aspect above.

In an eighth aspect, there is provided a network device. The network device comprises a processor and a memory. The memory is coupled to the processor and stores instructions thereon. The instructions, when executed by the processor, cause the network device to perform the method according to the second aspect above.

In a ninth aspect, there is provided a computer readable medium having instructions stored thereon, the instructions, when executed on at least one processor, causing the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2A illustrates an example TDRA table in accordance with some example embodiments of the present disclosure;

FIG. 2B illustrates example transmission occasion for PDSCHs and PUCCH in accordance with some example embodiments of the present disclosure;

FIG. 3 illustrates a signalling chart illustrating communication process in accordance with some embodiments of the present disclosure;

FIGS. 4A-4B illustrate example scenarios in which some embodiments of the present disclosure may be implemented;

FIGS. 5A-5B illustrate example scenarios in which some embodiments of the present disclosure may be implemented;

FIG. 6 illustrates a signalling chart illustrating communication process in accordance with some embodiments of the present disclosure;

FIGS. 7A-7D illustrates an example scenario in which some embodiments of the present disclosure may be implemented;

FIG. 8 illustrates a signalling chart illustrating communication process in accordance with some embodiments of the present disclosure;

FIG. 9 illustrates a flowchart of an example method in accordance with some embodiments of the present disclosure;

FIG. 10 illustrates a flowchart of an example method in accordance with some embodiments of the present disclosure;

FIG. 11 illustrates a flowchart of an example method in accordance with some embodiments of the present disclosure;

FIG. 12 illustrates a flowchart of an example method in accordance with some embodiments of the present disclosure;

FIG. 13 illustrates a flowchart of an example method in accordance with some embodiments of the present disclosure;

FIG. 14 illustrates a flowchart of an example method in accordance with some embodiments of the present disclosure; and

FIG. 15 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2(24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the context of the present disclose, the terms “acknowledgement”, “positive acknowledgement”, “ACK”, “HARQ”, “Hybrid automatic repeat request acknowledgement”, “HARQ-ACK”, “negative acknowledgement”, “NACK”, “NAK”, “ACK/NACK” and “ACK/NAK” can be used interchangeably. In the context of the present disclose, the terms “DCI”, “DCI format with information” and “DCI format” can be used interchangeably.

As stated above, to further improve scheduling efficiency, in release 18, one DCI is allowed to schedule multiple PDSCHs on multiple cells, where the multiple cells may also be called as multiple component carriers (CCs) in some scenarios. It is proposed that a fallback DCI, such as DCI formats 0_0 and 1_0, does not support multi-cell scheduling, and a DCI format 0-X or 1-X may be considered. In some examples, the DCI format 0-X/1-X on a scheduling cell can be used to schedule multiple physical uplink shared channels (PUSCHs) or PDSCHs on multiple cells including the scheduling cell. In some examples, the DCI format 0-X/1-X on a scheduling cell can be used to schedule multiple PUSCHs/PDSCHs on multiple cells not including the scheduling cell.

In the present disclosure, the term “multi-carrier DCI (MC-DCI)” may refer to one DCI scheduling for multiple carriers, one DCI scheduling for multiple cells, or the like. In the present disclosure, the term “slot” may refer to a dynamic scheduling unit. The slot used herein may refer to a normal slot which comprises a predetermined number of symbols, or may also refer to a sub-slot which comprises fewer symbols than the predetermined number of symbols.

Embodiments of the present disclosure provide a solution of communication. In the solution, a HARQ-ACK codebook for multiple PDSCHs on multiple cells which are scheduled by one DCI may be determined based a reference cell. As such, the MC-DCI can be supported and the communication efficiency may be improved. Principles and implementations of the present disclosure will be described in detail below with reference to the figures.

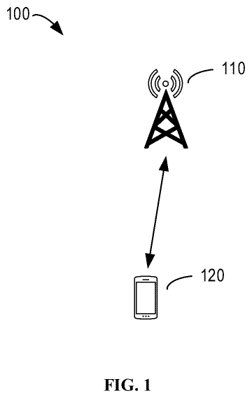

FIG. 1 illustrates an example communication system 100 in which some embodiments of the present disclosure can be implemented. The communication system 100, which is a part of a communication network, includes a network device 110 and a terminal device 120.

The network device 110 can provide services to the terminal device 120, and the network device 110 and the terminal device 120 may communicate data and control information with each other. In some embodiments, the network device 110 and the terminal device 120 may communicate with direct links/channels.

In the system 100, a link from the network devices 110 to the terminal device 120 is referred to as a downlink (DL), while a link from the terminal device 120 to the network devices 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). It is to be understood that the network device 110 may provide one or more serving cells. In some embodiments, the network device 110 can provide multiple cells.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure.

In some embodiments, the network device 110 can provide multiple cells. In some embodiments, a DCI may be used for scheduling PDSCH(s). In some example embodiments, a DCI may be used for scheduling one or more PDSCHs on one serving cell. In some embodiments, a DCI may be used for scheduling multiple PDSCHs on multiple cells, where at least one PDSCH is scheduled for any one of the multiple cells.

In some embodiments, a HARQ-ACK codebook may be used for the scheduled PDSCH(s). In some examples, the HARQ-ACK may be transmitted through a PUCCH. In some embodiments, the terminal device 120 may be configured with a type of HARQ codebook. For example, the type may be at least one of Type 1 (for example, static or semi-static), Type 2 (for example, dynamic) and Type 3 (one shot feedback). Further, the type may be configured via such as, an RRC, MAC CE or DCI. In some embodiments, the DCI is received/detected in a PDCCH.

In some embodiments, when MC-DCI is configured, i.e., one DCI scheduling for multi cells, all HARQ-ACK codebook types (i.e., type-1, type-2, and type-3) are applicable. Type-1 HARQ-ACK codebook, may also be called as type-1 codebook, can be regarded as a static codebook, in which the number of bits is static regardless of actual scheduling. One bit in type-1 codebook corresponds to an ACK/NACK result of PDSCH reception. All possible PDSCH occasions in time domain on all configured cells have corresponding position in the codebook. Due to all possible positions are included in the codebook, i.e. maximum possible length, bit length of type-1 codebook is static. If a PDSCH is not scheduled to receive, the feedback information may be set to ‘NACK’.

For enabling feedback of PDSCH, the terminal device 120 may be configured with a time domain resource allocation (TDRA) table and a value (represented as K1) to indicate a slot gap between a PDSCH reception slot and a PUCCH HARQ-ACK transmission slot. For example, the TDRA table and K1 may be configured via an RRC. In some examples, the TDRA table may also be called as a TDRA configuration, or a TDRA for short. It is to be understood that the configured TDRA and K1 are associated with a specific cell, for example, a primary cell (PCell).

In some embodiments, the terminal device 120 may be indicated with a row index of the configured TDRA table via a DCI. It is to be understood that PDSCHs are not expected to overlap even partially in time domain, thus there is a restriction on maximum number of possible TDRA indication, i.e., a maximum number of possible PDSCH in a slot. In some examples, the possible allocation in a slot may depend on the configured TDRA.

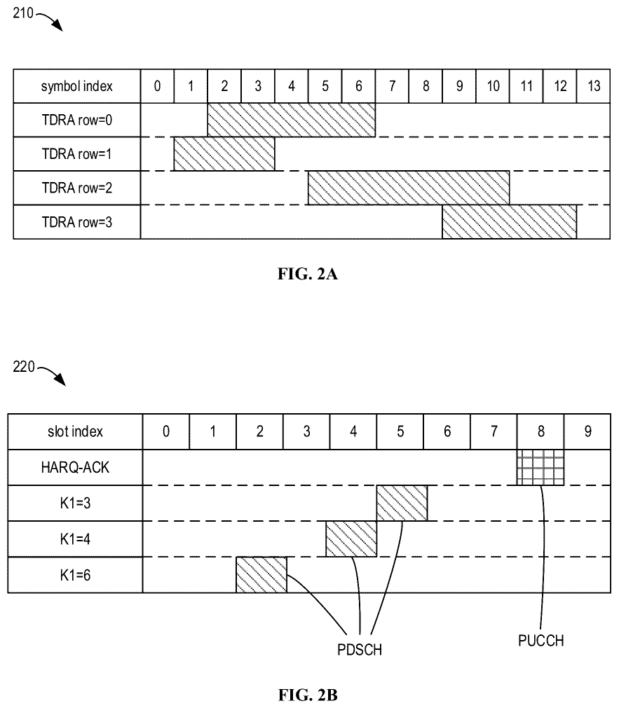

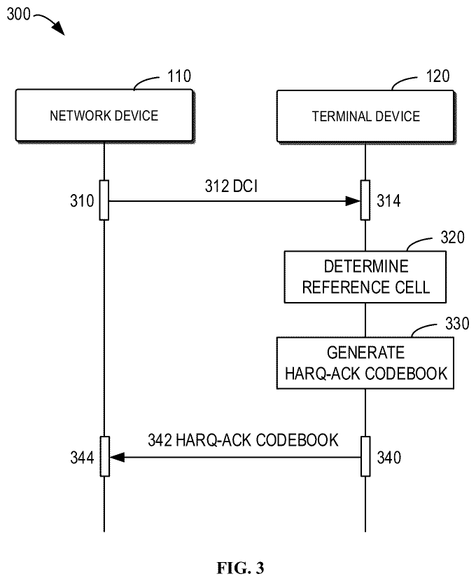

FIG. 2A illustrates an example TDRA table 210 according to some example embodiments of the present disclosure. There are four rows in the configured TDRA 210, row 0 to row 3. And it is determined that there are at most two possible allocations in a slot where PDSCHs cannot overlap with each other. For example, DCI may indicate only one row, such as any one of rows 0, 1, 2, and 3. For example, DCI may indicate row 0 and row 3 simultaneously. For example, DCI may indicate row 1 and row 2 simultaneously. For example, DCI may indicate row 1 and row 3 simultaneously. In this case, the maximum number of possible PDSCHs in a slot is 2, based on the configured TDRA 210 shown in FIG. 2A.

In some embodiments, a sequence of bits in a type-1 codebook is ordered firstly in all possible allocations in a slot, secondly in all possible slot occasions based on the configured K1 value from earlier to later. For example, it is assumed that the terminal device 120 is configured with a K1 set {3, 4, 6}. FIG. 2B illustrates example transmission occasions 220 for PDSCHs and PUCCH according to some example embodiments of the present disclosure. If a PUCCH HARQ-ACK transmission slot (i.e., the slot for HARQ-ACK transmission) is slot 8, it may be determined that the PDSCH receptions on slot 2, slot 4, and slot 5 are possible for scheduling.

It is to be understood that, as long as a TDRA table and a K1 set is configured for a cell (PCell for example), the number of bits in type-1 codebook may be determined. For example, it is determined that the number of bits in type-1 codebook is 6 according to FIGS. 2A-2B. The first 2 bits are used for K1=6, the middle 2 bits are used for K1-4 and the last 2 bits are used for K1=3.

In case MC-DCI is configured, one DCI may be used for configuring multiple PDSCHs on multiple cells. According to embodiments of the present disclosure, there is provided a solution for determining a HARQ-ACK codebook. In this solution, a terminal device may determine a reference cell from multiple cells and the number of bits in the HARQ-ACK codebook is determined based on the reference cell.

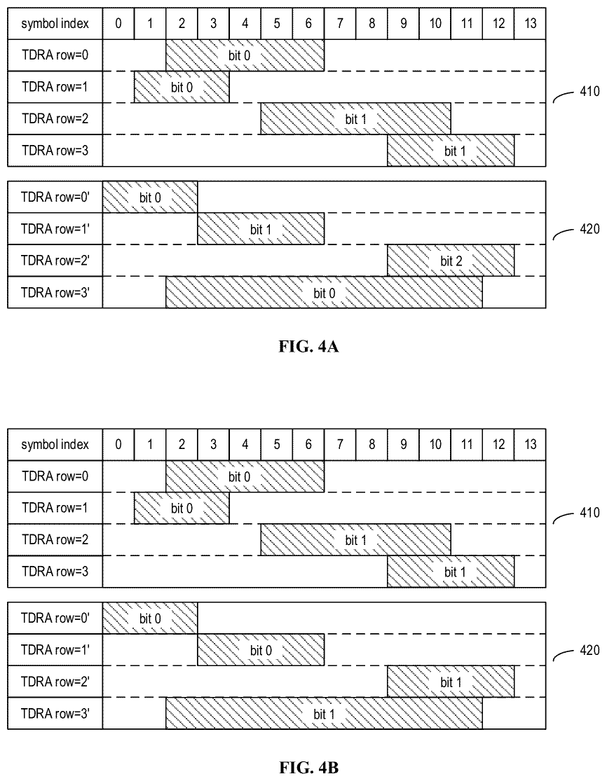

Reference is first made to FIG. 3, which illustrates a signalling chart illustrating communication process 300 in accordance with some example embodiments of the present disclosure. Only for the purpose of discussion, the process 300 will be described with reference to FIG. 1. The process 300 may involve the terminal device 120 and the network device 110.

In some embodiments of the present disclosure, the terminal device 120 is configured with a TDRA table and a K1 set associated with each cell. The configuration may be transmitted through an RRC from the network device 110 to the terminal device 120.

For example, there may be a first TDRA table and a first K1 set which are associated with a first cell. For example, there may be a second TDRA table and a second K1 set which are associated with a second cell. In some examples, the first K1 set is associated with (or corresponds to) the first TDRA table, and the second K1 set is associated with (or corresponds to) the second TDRA table. It is to be understood that the first K1 set includes at least one K1 value, the second K1 set also includes at least one K1 value. It is to be understood that the first K1 set and the second K1 set may be configured independently, a first value in the first K1 set may equal to or may not equal to a second value in the second K1 set, and the present disclosure does not limit this aspect.

The network device 110 transmits 310 a DCI 312 to the terminal device 120, where the DCI 312 schedules multiple PDSCHs on multiple cells. It is understood that one or more PDSCHs may be scheduled for a cell in the multiple cells. As an example but not limited embodiment, the multiple PDSCHs include a PDSCH 1 on cell 1 and PDSCHs 2 and 3 on cell 2. In some embodiments, the DCI 312 may indicate at least one row index.

On the other side of communication, the terminal device 120 receives 314 the DCI 312. In some embodiments, the terminal device 120 may blind detect PDCCH from the network device 110 and receive the DCI 312. The terminal device 120 determines 320 a reference cell from the multiple cells. The reference cell may be used for generating a HARQ-ACK codebook for the multiple PDSCHs scheduled by the DCI 312.

In some example embodiments, the reference cell may be indicated or be configured by the network device 110. For example, the scheduled first cell of the scheduled last cell in the multiple cells may be indicated as the reference cell. In some example embodiments, the terminal device 120 may determine a number of needed bits for each cell of the multiple cells, where the number of needed bits indicates a maximum number of possible PDSCHs in a slot for the cell. As such, multiple numbers of needed bits may be determined for the multiple cells, respectively. It is to be understood that the number of needed bits for a cell in a slot may be determined based on type-1 codebook generation procedure, and the present disclosure will not redundantly repeat herein.

For a specific cell in the multiple cells, its associated TDRA table may be used to determine the number of needed bits for the specific cell. Assume that a cell has an associated TDRA table as that shown in FIG. 2A, it is determined that the number of needed bits for the cell is 2, since the PDSCHs are not allowed to overlap even partially in time domain.

Specifically, a row with a smallest last symbol number (may be called as a bit-0-row) is determined, for example, row 1 as shown in FIG. 2A, the last symbol of row 1 is symbol 3. Further, one or more rows that overlap with the bit-0-row may be determined, for example, row 0 is overlapped with row 1. Thus, the bit-0-row and the one or more rows overlapping with the bit-0-row are all corresponding to bit 0. Additionally, a row, among the rest rows (rows 2 and 3 for example), with smallest last symbol number (may be called as a bit-1-row) is determined, for example, row 2 as shown in FIG. 2A, the last symbol of row 2 is symbol 10. Further, one or more rows, among the rest rows, that overlap with the bit-1-row may be determined, for example, row 3 is overlapped with row 2. Thus, the bit-1-row and the one or more rows overlapping with the bit-1-row are all corresponding to bit 1. It is to be understood that more bits may be determined if there are still some other rows and the present disclosure does not limit this aspect.

In some example embodiments, the terminal device 120 may determine the smallest number in the multiple numbers of needed bits, and accordingly the cell with the smallest number may be determined as the reference cell. In some examples, there may be more than one cell all with the smallest number; in this case, a cell with a lowest or highest index, among the more than one cell, may be determined as the reference cell.

As a specific example, assume that the multiple cells include a cell 1, a cell 2 and a cell 3. If the numbers of needed bits for the cells 1, 2, and 3 are 2, 3, and 3 respectively, then the cell 1 may be determined as the reference cell. If the numbers of needed bits for the cells 1, 2, and 3 are 2, 2, and 3 respectively, and an index of cell 1 is smaller than an index of cell 2, then the cell 1 (or the cell 2) may be determined as the reference cell.

The terminal device 120 generates 330 a HARQ-ACK codebook for the multiple PDSCHs on the multiple cells. In some embodiments, the HARQ-ACK codebook comprises multiple bit groups corresponding to the multiple cells, and each bit group has a same number of bits equals to the number of needed bits for the reference cell as described above. As a specific example, if the number of needed bits for the reference cell is 2, and there are 3 cells scheduled by the DCI 312, the generated HARQ-ACK codebook may include 6 bits. In some embodiments, the HARQ-ACK codebook generated by the terminal device 120 is a type-1 codebook.

In some embodiments, a bit in the HARQ-ACK codebook may be associated with a row index of a TDRA table. The HARQ-ACK codebook may comprise multiple bit groups corresponding to the multiple cells. It is assumed that the multiple bit groups comprise a first bit group corresponding to a first cell and a reference bit group corresponding to the reference cell. In some embodiment, a first bit in the first bit group corresponds to a first PDSCH with a first row index, a reference bit in the reference bit group corresponds to a reference PDSCH with a reference row index, and the first row index equals to the reference row index. In some embodiments, a position of the first bit in the first bit group is the same as a position of the reference bit in the reference bit group.

It is to be understood that the terminal device 120 may determine a first bit position for a first PDSCH on the first cell based on a reference bit position for a reference PDSCH on the reference cell, where the first bit position is a position of a first bit in a first bit group for a first cell and the reference bit position is a position of a reference bit in a reference bit group, and where the first PDSCH corresponds to a first row index in a first TDRA associated with the first cell and the reference PDSCH corresponds to a reference row index in a reference TDRA associated with the reference cell, and where the first row index is the same as the reference row index.

In other words, after removing row index of TDRA of a first cell based on TDD-UL-DL configuration that allocated PDSCH overlapping with UL symbol, a position of a first row index allocated PDSCH on the first cell is the same as a position of the same first index allocated PDSCH on the reference cell.

The terminal device 120 transmits 340 the HARQ-ACK codebook 342 to the network device 110. In some embodiments, the terminal device 120 may determine a slot for PUCCH based on the DCI 312, and the terminal device 120 may transmit the HARQ-ACK codebook 342 in the slot for the PUCCH. On the other side of communication, the network device 110 receives 344 the HARQ-ACK codebook.

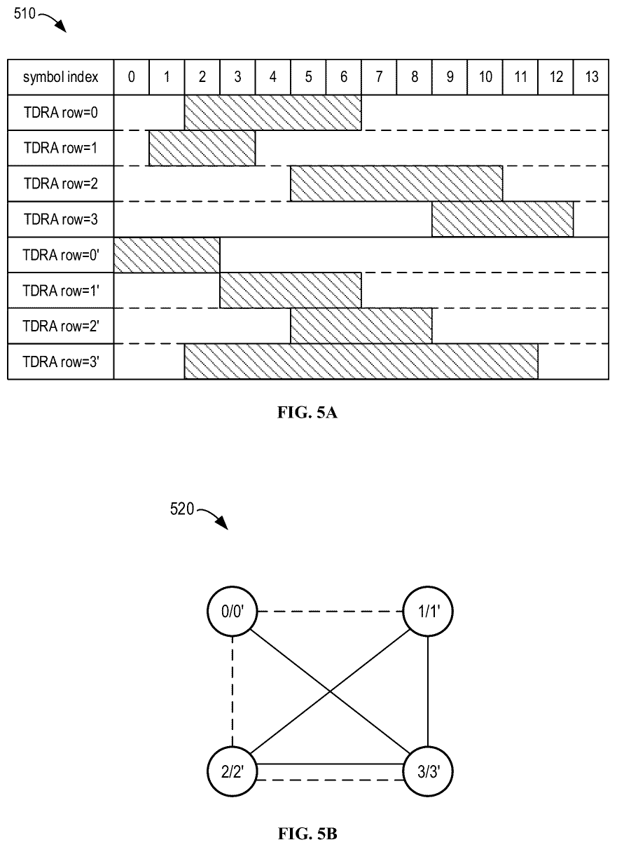

For better understanding, reference is now made to FIGS. 4A-4B illustrating example scenarios in which some embodiments of the present disclosure may be implemented. As shown in FIG. 4A, there are a first TDRA table 410 associated with a first cell and a second TDRA table 420 associated with a second cell. The terminal device 120 may determine that the needed bits for the first cell is 2 based on the first TDRA table 410, and the terminal device 120 may determine that the needed bits for the second cell is 3 based on the second TDRA table 420. Since 2<3, the terminal device 120 may determine that the first cell is the reference cell.

As shown in FIG. 4B, the association between the bits and the row index may be determined based on that for the reference cell, i.e. the first cell. Specifically, as shown in FIG. 4B, for both the first cell and the second cell, bit 0 is associated with rows 0/0′ and 1/1′, bit 1 is associated with rows 2/2′ and 3/3′. As such, when MC-DCI is applied, the length of bits in a type-1 HARQ-ACK codebook in a slot may be determined based on a reference cell. Accordingly, the proceeding complexity for generating a type-1 HARQ-ACK codebook may be reduced. Alternatively, in some other example embodiments, an exhaustion method may be used by the terminal device 120 to find the largest number of set of row index, based on multiple TDRA tables associated with the multiple cells.

In some embodiments, after removing row index of TDRA on a specific cell based on the UL symbol configuration of the specific cell, within the remaining TDRA on all cells, the terminal device 120 may find the largest number of set of row index, that the corresponding PDSCHs are not overlapped in time domain in any cell. In some examples, if more than one set is found, the terminal device 120 may select one set, for example, the smallest/largest sum of index within the set among the sets. It is to be understood that the exhaustion method in the present disclosure may be any executable method and the present disclosure does not limit this aspect. In some embodiments, a graph with node and edge may be considered.

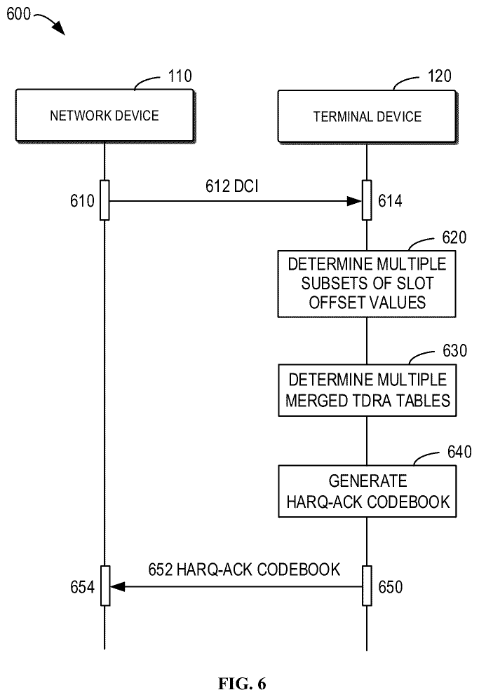

Reference is now made to FIGS. 5A-5B, which illustrate example scenarios in which some embodiments of the present disclosure may be implemented. FIG. 5A illustrates example TDRA tables 510 associated with two cells respectively. In some examples, each row index in the TDRA tables 510 may be regarded as a node in a graph. If PDSCHs of a row index and another row index are overlapped in the time domain in any cell, an edge is added between a node representing a row index and a node representing another row index. FIG. 5B illustrates an example graph 520 with nodes and edges according to the TDRA tables 510 in FIG. 5A. In FIG. 5B, dash lines may indicate the PDSCH overlapping based on rows 0-3 in FIG. 5A, and solid lines may indicate the PDSCH overlapping based on rows 0′-3′ in FIG. 5B.

In some embodiment, the terminal device 120 may find (or determine) the largest number of subset of the node that no edge between any node in the subset. The subset may be called as an independent set, and in some cases, the problem may be regarded as well known “clique problem” which is a NP-hard problem. As such, according to the exhaustion method, an optimal length of bits in a type-1 HARQ-ACK codebook in a slot may be determined, therefore the best performance may be maintained.

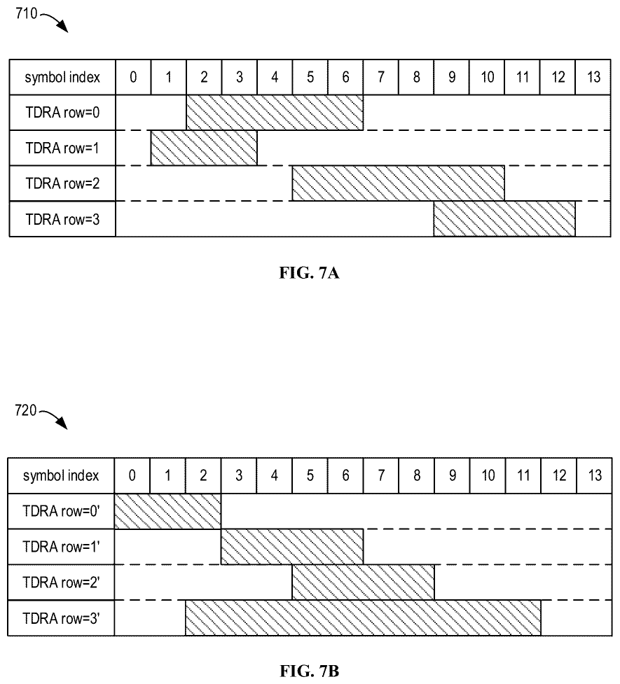

Reference is further made to FIG. 6, which illustrates a signalling chart illustrating communication process 600 in accordance with some example embodiments of the present disclosure. Only for the purpose of discussion, the process 600 will be described with reference to FIG. 1. The process 300 may involve the terminal device 120 and the network device 110.

In some embodiments of the present disclosure, the terminal device 120 is configured with a TDRA table and a K1 set associated with each cell. The configuration may be transmitted through an RRC from the network device 110 to the terminal device 120.

For example, there may be a first TDRA table and a first K1 set which are associated with a first cell. For example, there may be a second TDRA table and a second K1 set which are associated with a second cell. In some examples, the first K1 set is associated with (or corresponds to) the first TDRA table, and the second K1 set is associated with (or corresponds to) the second TDRA table. It is to be understood that the first cell and the second cell may be a same cell, in this case, both the first TDRA (and/or corresponded first K1 set) and the second TDRA (and/or corresponded second K1 set) are configured for the first cell.

It is to be understood that the first K1 set includes at least one K1 value, the second K1 set also includes at least one K1 value. It is to be understood that the first K1 set and the second K1 set may be configured independently, a first value in the first K1 set may equal to or may not equal to a second value in the second K1 set, and the present disclosure does not limit this aspect.

The network device 110 transmits 610 a DCI 612 to the terminal device 120, where the DCI 612 schedules multiple PDSCHs on multiple cells. It is understood that one or more PDSCHs may be scheduled for a cell in the multiple cells. As an example but not limited embodiment, the multiple PDSCHs include a PDSCH 1 on cell 1 and PDSCHs 2 and 3 on cell 2. In some embodiments, the DCI 612 may indicate at least one row index.

On the other side of communication, the terminal device 120 receives 614 the DCI 612. In some embodiments, the terminal device 120 may blind detect PDCCH from the network device 110 and receive the DCI 612. The terminal device 120 determines 620 multiple subsets of slot offset values, which may also be called as multiple K1 subsets. In some embodiments, each K1 subset may include one or more K1 values, and a K1 value may indicate a slot gap between a slot of a PDSCH and a slot of HARQ-ACK codebook. The terminal device 120 determines 630 multiple merged TDRA tables based on the multiple subsets of slot offset values (i.e., multiple K1 subsets).

In some example embodiments, the multiple K1 subsets may be configured by the network device 110. In some examples, the network device 110 may transmits a configuration indicating the multiple K1 subsets to the terminal device 120. In this event, the terminal device 120 may determine the multiple K1 subsets based on the configuration. In some embodiments, if a first K1 subset include only one value, and if the one value only belong a first K1 set associated with a first TDRA table, then the terminal device 120 may that the merged TDRA table corresponding to the first K1 subset is the first TDRA table.

In some embodiments, if a second K1 subset include one (or more) value, and if the one value belongs to both a second K1 set and a third K1 set, then the terminal device 120 may that the merged TDRA table corresponding to the second K1 subset is generated by merging a second TDRA table associated with the second K1 set and a third TDRA table associated with the third K1 set.

In some embodiments, if a third K1 subset include two (or more) values, and if one value belongs to a fourth K1 set and another value belongs to a fifth K1 set, then the terminal device 120 may that the merged TDRA table corresponding to the third K1 subset is generated by merging a fourth TDRA table associated with the fourth K1 set and a fifth TDRA table associated with the fifth K1 set.

The terminal device 120 generates 640 a HARQ-ACK codebook based on the multiple merged TDRA tables and the multiple subsets of slot offset values (i.e., multiple K1 subsets). In some example embodiments, for a slot corresponding to a K1 value in a K1 subset, the terminal device 120 may determine a HARQ-ACK sub-codebook based on the a merged TDRA table corresponding to the K1 subset. And further the HARQ-ACK codebook can be generated based on all HARQ-ACK sub-codebooks associated with all slots in all the K1 subsets.

The terminal device 120 transmits 650 the HARQ-ACK codebook 652 to the network device 110. In some embodiments, the terminal device 120 may determine a slot for PUCCH based on the DCI 612, and the terminal device 120 may transmit the HARQ-ACK codebook 652 in the slot for the PUCCH. On the other side of communication, the network device 110 receives 654 the HARQ-ACK codebook 652.

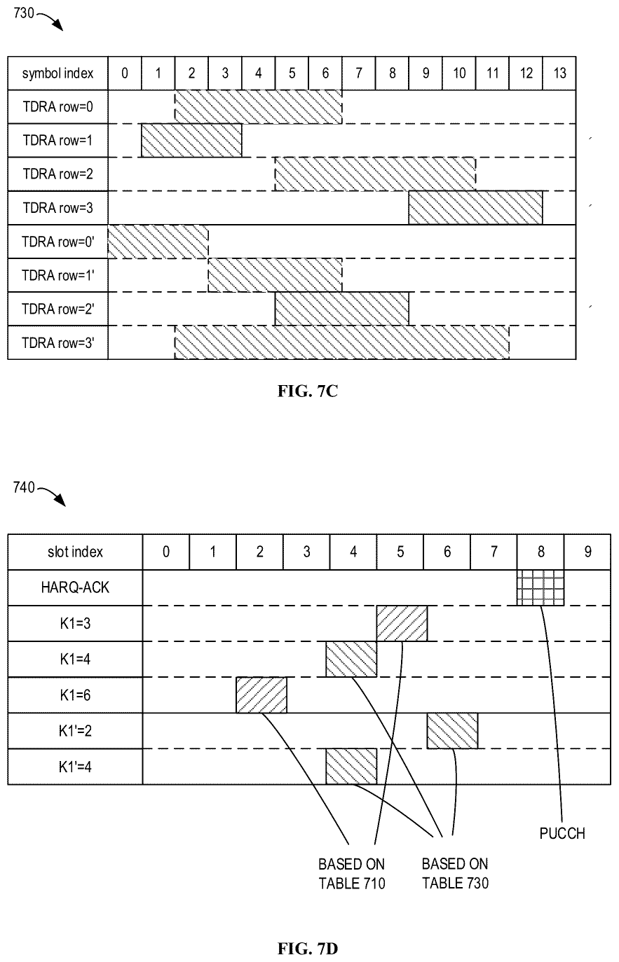

For better understanding, reference is now made to FIGS. 7A-7D, which illustrates an example scenario in which some embodiments of the present disclosure may be implemented. It is assumed that a first TDRA table and a first K1 set are configured, and a second TDRA table and a second K1 set are also configured. For example, the first TDRA table is shown in FIG. 7A and the second TDRA table is shown in FIG. 7B. It is assumed that the first K1 set includes K1 values 3, 4, and 6, which is represented as {3, 4, 6}; and the second K1 set includes K1 values 2 and 4, which is represented as {2, 4}.

In some examples, two K1 subsets are configured. A first K1 subset includes K1 values 3 and 6, which is represented as {3, 6}, and a second K1 subset includes K1 values 2 and 4, which is represented as {2, 4}. Since the K1 values 3 and 6 both are in the first K1 set, but none in the second K1 set, the first merged TDRA table associated with the first K1 subset is the same as the first TDRA table shown in FIG. 7A. Since the K1 values 2 and 4 both are in the second K1 set, and the K1 value 4 is also in the first K1 set, the second merged TDRA table associated with the second K1 subset is generated by merging the first TDRA table and the second TDRA table, for example, the second merged TDRA table is shown in FIG. 7C. And it is determined that the maximum possible length based on the merged TDRA table is 3, for example, row 1, row 3 and row 2′, as shown in FIG. 7C.

If a PUCCH HARQ-ACK transmission slot (i.e., the slot for HARQ-ACK transmission) is slot 8, it may be determined that the PDSCH receptions on slot 2, slot 4, slot 5 and slot 6 are possible for scheduling based on all K1 values, as shown in FIG. 7D. In some examples, the bits of a HARQ-ACK sub-codebook in slot 2 and the bits of a HARQ-ACK sub-codebook in slot 5 are determined based on the first merged TDRA table, and the bits of HARQ-ACK sub-codebook in slot 4 and the bits of a HARQ-ACK sub-codebook in slot 6 are determined based on the second merged TDRA table.

It is determined that the maximum possible length for the first merged table as shown in FIG. 7A is 2 and the maximum possible length for the second merged table as shown in FIG. 7C is 3. Thus, the terminal device 120 may determine that the HARQ-ACK codebook includes 13 bits, which comprise 2 bits for slot 2, 3 bits plus 3 bits for slot 4, 2 bits for slot 5, and 3 bits for slot 6.

In some other example embodiments, it is proposed that DCI format 1-0 (or 1-1, 1-2) may not support MC-DCI and DCI format 1-X may support MC-DCI. For ease of description, DCI format 1-0 and DCI format 1-X are considered in the following embodiments. In some example embodiments, for a specific cell, a TDRA table and/or a K1 set configured for DCI format 1-X may be different from that configured for DCI 1-0.

Considering a specific cell of the multiple cells, a first cell for example, a TDRA table and/or a K1 set may be configured for DCI 1-X, and another TDRA table and/or another K1 set may be configured for DCI 1-0. In some example embodiments, a TDRA table and/or a K1 set may be configured for DCI 1-X for the first cell, but either TDRA table or K1 set may is configured for DCI 1-0. In this case, the TDRA table and/or K1 set configured for DCI 1-0 for the first cell may be determined based on the TDRA table and/or the K1 set configured for DCI 1-X for the first cell.

In some examples, if the first cell is configured with a TDRA table and/or a K1 set for DCI format 1-X (i.e., MC-DCI) but not configured with a TDRA table or a K1 set for DCI format 1-0, then the TDRA table configured for DCI format 1-X may be used as the TDRA table for DCI format 1-0.

In some examples, there is an indicated offset value of a slot gap between a slot of a PDSCH (for example, the last scheduled PDSCH) and a slot of a PUCCH, for example, the indicated offset value may be represented as K1. In some examples, the indicated offset value may be associated with a cell (same as the first cell or different from the first cell, called as a basic cell for example) based on a subcarrier spacing (SCS) unit of a scheduled PDSCH for the cell. In some examples, there is an indicated offset value of a slot gap between a slot of a PDSCH on a cell and a slot of a PDCCH (DCI) scheduling the PDSCH, for example, the indicated offset value may be represented as K0. If SCS of the basic cell and the first cell is different, K0 for the first cell is aligned with SCS of the basic cell. Further, a K1 value in the K1 set for the first cell may be determined as the indicated offset value (K1) plus a delta slot value, where the delta slot value is determined based on a slot number of PDSCH for the basic cell (K0 for the basic cell) minus a slot number of PDSCH for the first cell (K0for the first cell). As such, the K1 set for DCI 1-0 for the first cell may be determined. As such, the K1 set for DCI 1-X for the first cell for type-1 codebook may be determined.

In some embodiments, three K1 subsets may be configured for the specific cell (the first cell for example). For example, K1 subset 1 is associated with a TDRA table for DCI 1-X, K1 subset 2 is associated with a TDRA table for DCI 1-0, and K1 subset 3 is associated with a merged TDRA table for DCI 1-X and DCI 1-0, where the merged TDRA table may be a union TDRA table by merging a TDRA table for DCI 1-X and a TDRA table for DCI 1-0. Accordingly, three HARQ-ACK sub-codebooks may be generated. For example, sub-codebook 1 is generated based on K1 subset 1 and the TDRA table for DCI 1-X, sub-codebook 2 is generated based on K1 subset 2 and the TDRA table for DCI 1-0, and sub-codebook 3 is generated based on K1 subset 3 and the union TDRA table. It is to be understood that three HARQ-ACK sub-codebooks may be generated for each cell in the multiple cells according to the similar procedure, and therefore the HARQ-ACK codebook for multiple cells may be generated.

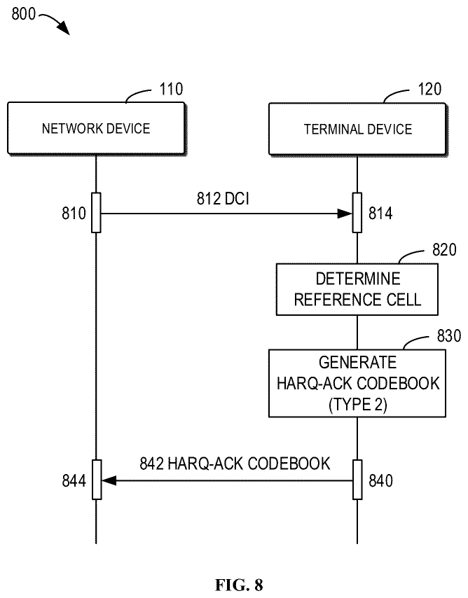

Reference is further made to FIG. 8, which illustrates a signalling chart illustrating communication process 800 in accordance with some example embodiments of the present disclosure. Only for the purpose of discussion, the process 800 will be described with reference to FIG. 1. The process 800 may involve the terminal device 120 and the network device 110. The network device 110 transmits 810 a DCI 812 to the terminal device 120, where the DCI 812 schedules multiple PDSCHs on multiple cells. It is understood that one or more PDSCHs may be scheduled for a cell in the multiple cells. As an example but not limited embodiment, the multiple PDSCHs include a PDSCH 1 on cell 1 and PDSCHs 2 and 3 on cell 2. In some embodiments, the DCI 812 may indicate a downlink assignment index (DAI) value.

On the other side of communication, the terminal device 120 receives 814 the DCI 812. In some embodiments, the terminal device 120 may blind detect PDCCH from the network device 110 and receive the DCI 812. The terminal device 120 determines 820 a reference cell from the multiple cells. The reference cell may be used for generating a HARQ-ACK codebook for the multiple PDSCHs scheduled by the DCI 812.

In some example embodiments, the reference cell may be indicated or be configured by the network device 110. For example, the scheduled first cell of the scheduled last cell in the multiple cells may be indicated as the reference cell. In some example embodiments, the reference cell may be a cell with a lowest index among the multiple cells. In some example embodiments, the reference cell may be a cell with a highest index among the multiple cells. In some example embodiments, the reference cell may be a cell with a last slot of scheduled multiple PDSCHs. In some embodiments, the HARQ-ACK codebook discussed in process 800 may be a type-2 HARQ-ACK codebook, or type-2 codebook for short.

The terminal device 120 generates 830 a HARQ-ACK codebook for the multiple PDSCHs on the multiple cells. In some embodiments, the HARQ-ACK codebook comprises multiple bits in an increasing order of a PDSCH reception starting time on the reference cell. In some embodiments, the type-2 HARQ-ACK codebook is generated based on the DAI value indicated by the DCI 812.

In some example embodiments, the type-2 HARQ-ACK codebook comprises multiple bits, and an order of the bits is: (1) first, when one DCI schedules multiple PDSCHs on multiple cells and if more than one DCI (thus one PDSCH) are scheduled from a same PDCCH monitoring occasion, in an increasing order of the PDSCH reception starting time on the reference cell for the same {serving cell, PDCCH monitoring occasion} pair; (2) second, in an ascending order of serving cell index; and (3) third, in an ascending order of PDCCH monitoring occasion index m, where 0≤m<M and Mrepresents the total number of PDCCH monitoring occasions.

It is to be understood that different PDSCHs on a same cell may have different starting time, but different PDSCHs on different cells may have a same starting time. According to the present disclosure, a reference cell is considered so that the starting time can be unique and the order of bits may be deterministic. It is to be understood that a DCI may not schedule actual PDSCH reception on the reference cell, in other words, the reference cell which is used for determining the starting time is not scheduled; in this case, a virtual PDSCH allocation may be determined, for example, based on the indicated row index of a TDRA table associated with the reference cell.

The terminal device 120 transmits 840 the HARQ-ACK codebook 842 to the network device 110. And accordingly, the network device 110 receives 844 the HARQ-ACK codebook 842. As such, a type-2 HARQ-ACK codebook may be generated with a deterministic order since the reference cell has a unique starting time.

According to the embodiments described with reference to FIG. 3 to FIG. 8, the terminal device may generate a HARQ-ACK codebook for multiple PDSCHs on multiple cells, thus MC-DCI may be supported and the communication efficiency may be improved.

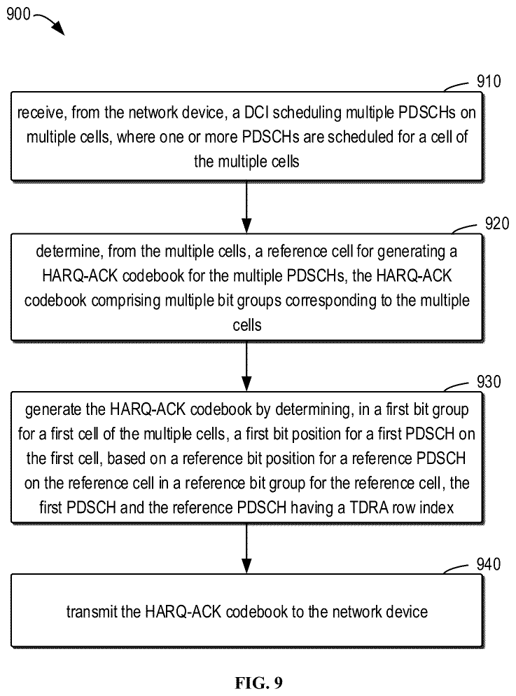

FIG. 9 illustrates a flowchart of an example method 900 implemented at a terminal device in accordance with some embodiments of the present disclosure. For the purpose of discussion, the method 900 will be described from the perspective of the terminal device 120 with reference to FIG. 1.

At block 910, the terminal device 120 receives, from the network device 110, a DCI scheduling multiple PDSCHs on multiple cells, where one or more PDSCHs are scheduled for a cell of the multiple cells. At block 920, the terminal device 120 determines, from the multiple cells, a reference cell for generating a HARQ-ACK codebook for the multiple PDSCHs, the HARQ-ACK codebook comprising multiple bit groups corresponding to the multiple cells. At block 930, the terminal device 120 generates the HARQ-ACK codebook by determining, in a first bit group for a first cell of the multiple cells, a first bit position for a first PDSCH on the first cell, based on a reference bit position for a reference PDSCH on the reference cell in a reference bit group for the reference cell, the first PDSCH and the reference PDSCH having a TDRA row index. At block 940, the terminal device 120 transmits the HARQ-ACK codebook to the network device 110.

In some example embodiments, the first bit position is the same as the reference bit position. In some example embodiments, each of the multiple bit groups comprises a same number of bits, the number being determined based on a TDRA table for the reference cell.

In some example embodiments, the reference cell among the multiple cells is a cell with a smallest number of needed bits for a corresponding bit group, a lowest index among cells with a same smallest number of needed bits for a corresponding bit group, a highest index among cells with the same smallest number of needed bits for a corresponding bit group, or any combination thereof.

In some example embodiments, each of the multiple bit groups comprises a same number of bits equal to the smallest number of needed bits.

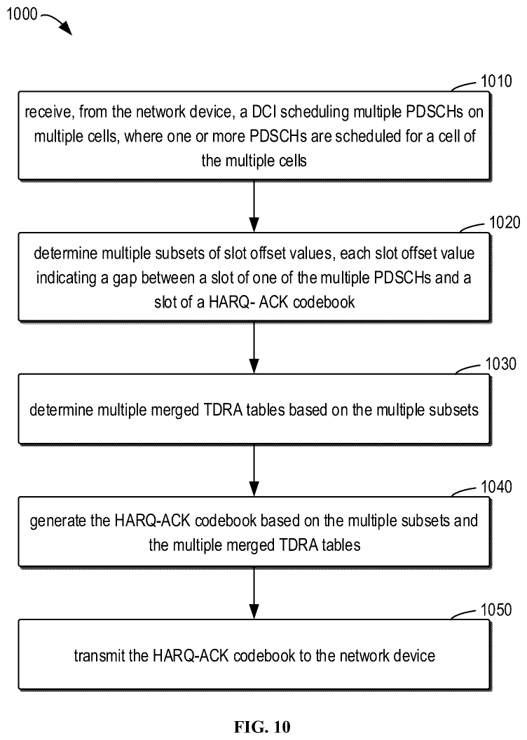

FIG. 10 illustrates a flowchart of an example method 1000 implemented at a terminal device in accordance with some embodiments of the present disclosure. For the purpose of discussion, the method 1000 will be described from the perspective of the terminal device 120 with reference to FIG. 1.

At block 1010, the terminal device 120 receives, from the network device 110, a DCI scheduling multiple PDSCHs on multiple cells, where one or more PDSCHs are scheduled for a cell of the multiple cells. At block 1020, the terminal device 120 determines multiple subsets of slot offset values, each slot offset value indicating a gap between a slot of one of the multiple PDSCHs and a slot of a HARQ-ACK codebook. At block 1030, the terminal device 120 determines multiple merged TDRA tables based on the multiple subsets. At block 1040, the terminal device 120 generates the HARQ-ACK codebook based on the multiple subsets and the multiple merged TDRA tables. At block 1050, the terminal device 120 transmits the HARQ-ACK codebook to the network device 110.

In some example embodiments, the terminal device 120 determines a first subset of the multiple subsets includes multiple values; and if a first value set corresponding to a first TDRA table comprises one of the multiple values and that a second value set corresponding to a second TDRA table comprises another one of the multiple values, the terminal device 120 generates a merged TDRA table of the multiple merged TDRA tables by merging the first TDRA table and the second TDRA table.

In some example embodiments, the terminal device 120 determines a second subset of the multiple subsets includes one value; and if both a first value set corresponding to a first TDRA table and a second value set corresponding to a second TDRA table comprise the value, the terminal device 120 generates a merged TDRA table of the multiple merged TDRA tables by merging the first TDRA table and the second TDRA table.

In some example embodiments, the terminal device 120 obtains a slot offset value indicated by the DCI; determines multiple slot offset values corresponding to the multiple cells, based on the slot offset value indicated by the DCI; and generates the multiple subsets each comprising one of the multiple slot offset values.

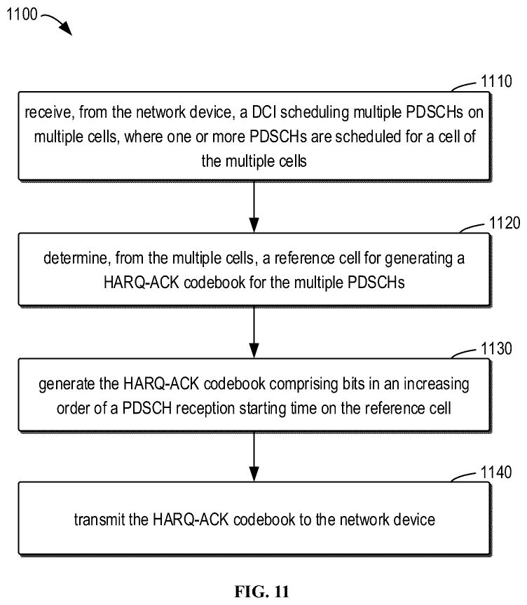

FIG. 11 illustrates a flowchart of an example method 1100 implemented at a terminal device in accordance with some embodiments of the present disclosure. For the purpose of discussion, the method 1100 will be described from the perspective of the terminal device 120 with reference to FIG. 1.

At block 1110, the terminal device 120 receives, from the network device 110, a DCI scheduling multiple PDSCHs on multiple cells, where one or more PDSCHs are scheduled for a cell of the multiple cells. At block 1120, the terminal device 120 determines, from the multiple cells, a reference cell for generating a HARQ-ACK codebook for the multiple PDSCHs. At block 1130, the terminal device 120 generates the HARQ-ACK codebook comprising bits in an increasing order of a PDSCH reception starting time on the reference cell. At block 1140, the terminal device 120 transmits the HARQ-ACK codebook to the network device 110.

In some example embodiments, the reference cell among the multiple cells is a cell with a last slot of scheduled PDSCHs, a lowest index, a highest index, or any combination thereof.

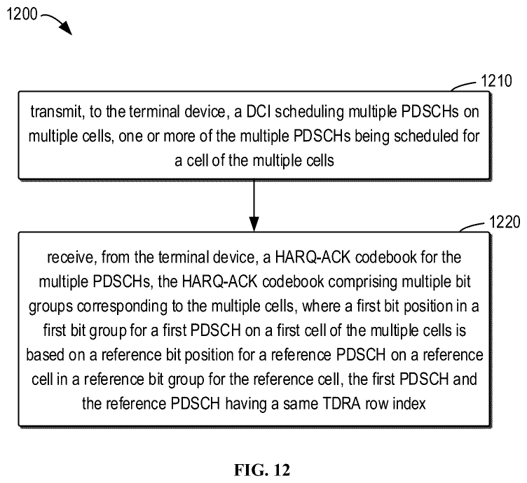

FIG. 12 illustrates a flowchart of an example method 1200 implemented at a network device in accordance with some embodiments of the present disclosure. For the purpose of discussion, the method 1300 will be described from the perspective of the network device 110 with reference to FIG. 1.

At block 1210, the network device 110 transmits, to the terminal device 120, a DCI scheduling multiple PDSCHs on multiple cells, one or more of the multiple PDSCHs being scheduled for a cell of the multiple cells. At block 1220, the network device 110 receives, from the terminal device 120, a HARQ-ACK codebook for the multiple PDSCHs, the HARQ-ACK codebook comprising multiple bit groups corresponding to the multiple cells, where a first bit position in a first bit group for a first PDSCH on a first cell of the multiple cells is based on a reference bit position for a reference PDSCH on a reference cell in a reference bit group for the reference cell, the first PDSCH and the reference PDSCH having a same TDRA row index.

In some example embodiments, the first bit position is the same as the reference bit position. In some example embodiments, each of the multiple bit groups comprises a same number of bits, the number being determined based on a TDRA table of the reference cell.

In some example embodiments, the reference cell among the multiple cells is a cell with a smallest number of needed bits for a corresponding bit group, a lowest index among cells with a same smallest number of needed bits for a corresponding bit group, or a highest index among cells with the same smallest number of needed bits for a corresponding bit group, or any combination thereof.

In some example embodiments, each of the multiple bit groups comprises a same number of bits equal to the smallest number of needed bits.

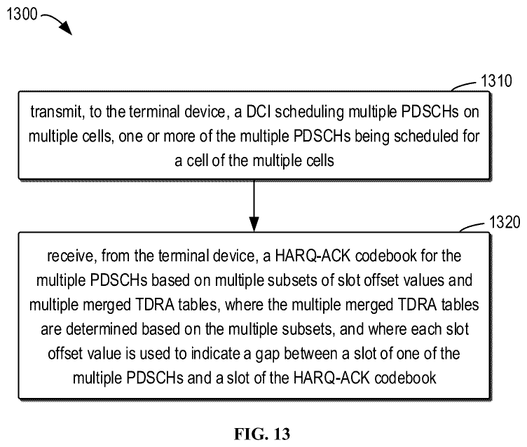

FIG. 13 illustrates a flowchart of an example method 1300 implemented at a network device in accordance with some embodiments of the present disclosure. For the purpose of discussion, the method 1300 will be described from the perspective of the network device 110 with reference to FIG. 1.

At block 1310, the network device 110 transmits, to the terminal device 120, a DCI scheduling multiple PDSCHs on multiple cells, one or more of the multiple PDSCHs being scheduled for a cell of the multiple cells. At block 1320, the network device 110 receives, from the terminal device 120, a HARQ-ACK codebook for the multiple PDSCHs based on multiple subsets of slot offset values and multiple merged TDRA tables, where the multiple merged TDRA tables are determined based on the multiple subsets, and where each slot offset value is used to indicate a gap between a slot of one of the multiple PDSCHs and a slot of the HARQ-ACK codebook.

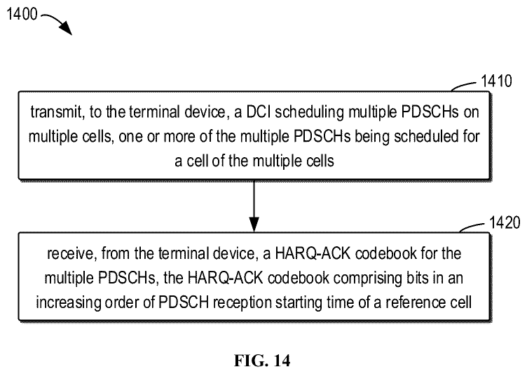

FIG. 14 illustrates a flowchart of an example method 1400 implemented at a network device in accordance with some embodiments of the present disclosure. For the purpose of discussion, the method 1400 will be described from the perspective of the network device 110 with reference to FIG. 1.

At block 1410, the network device 110 transmits, to the terminal device 120, a DCI scheduling multiple PDSCHs on multiple cells, one or more of the multiple PDSCHs being scheduled for a cell of the multiple cells. At block 1420, the network device 110 receives, from the terminal device 120, a HARQ-ACK codebook for the multiple PDSCHs, the HARQ-ACK codebook comprising bits in an increasing order of PDSCH reception starting time of a reference cell.

In some example embodiments, the reference cell among the multiple cells is a cell with a last slot of scheduled PDSCHs, a lowest index, a highest index, or any combination thereof.

Details of some embodiments according to the present disclosure have been described with reference to FIGS. 1-14. Now an example implementation of the terminal device and the network device will be discussed below.

In some example embodiments, a terminal device comprises circuitry configured to: receive, from a network device, a DCI scheduling multiple PDSCHs on multiple cells, where one or more PDSCHs are scheduled for a cell of the multiple cells; determine, from the multiple cells, a reference cell for generating a HARQ-ACK codebook for the multiple PDSCHs, the HARQ-ACK codebook comprising multiple bit groups corresponding to the multiple cells; generate the HARQ-ACK codebook by determining, in a first bit group for a first cell of the multiple cells, a first bit position for a first PDSCH on the first cell, based on a reference bit position for a reference PDSCH on the reference cell in a reference bit group for the reference cell, the first PDSCH and the reference PDSCH having a TDRA row index; and transmit the HARQ-ACK codebook to the network device 110.

In some example embodiments, the first bit position is the same as the reference bit position. In some example embodiments, each of the multiple bit groups comprises a same number of bits, the number being determined based on a TDRA table for the reference cell.

In some example embodiments, the reference cell among the multiple cells is a cell with at least one of: a smallest number of bits for a corresponding bit group, a lowest index among cells with a same smallest number of bits for a corresponding bit group, or a highest index among cells with the same smallest number of bits for a corresponding bit group.

In some example embodiments, each of the multiple bit groups comprises a same number of bits equal to the smallest number of bits.

In some example embodiments, a terminal device comprises circuitry configured to: receive, from the network device, a DCI scheduling multiple PDSCHs on multiple cells, where one or more PDSCHs are scheduled for a cell of the multiple cells; determine multiple subsets of slot offset values, each slot offset value indicating a gap between a slot of one of the multiple PDSCHs and a slot of a HARQ-ACK codebook; determine multiple merged TDRA tables based on the multiple subsets; generate the HARQ-ACK codebook based on the multiple subsets and the multiple merged TDRA tables; and transmit the HARQ-ACK codebook to the network device.

In some example embodiments, a terminal device comprises circuitry configured to: determine a first subset of the multiple subsets includes multiple slot offset values; and if a first set of slot offset values corresponding to a first TDRA table comprises one of the multiple values and that a second set of slot offset values corresponding to a second TDRA table comprises another one of the multiple slot offset values, generate a merged TDRA table of the multiple merged TDRA tables by merging the first TDRA table and the second TDRA table.

In some example embodiments, a terminal device comprises circuitry configured to: determine a second subset of the multiple subsets includes one slot offset value; and if both a first set of slot offset values corresponding to a first TDRA table and a second set of slot offset values corresponding to a second TDRA table comprise the slot offset value, generate a merged TDRA table of the multiple merged TDRA tables by merging the first TDRA table and the second TDRA table.

In some example embodiments, a terminal device comprises circuitry configured to: obtain a slot offset value indicated by the DCI; determines multiple slot offset values corresponding to the multiple cells, based on the slot offset value indicated by the DCI; and generate the multiple subsets each comprising one of the multiple slot offset values.

In some example embodiments, a terminal device comprises circuitry configured to: receive, from the network device, a DCI scheduling multiple PDSCHs on multiple cells, where one or more PDSCHs are scheduled for a cell of the multiple cells; determine, from the multiple cells, a reference cell for generating a HARQ-ACK codebook for the multiple PDSCHs; generate the HARQ-ACK codebook comprising bits in an increasing order of a PDSCH reception starting time on the reference cell; and transmit the HARQ-ACK codebook to the network device.

In some example embodiments, the reference cell among the multiple cells is a cell with at least one of: a last slot of scheduled PDSCHs, a lowest index, or a highest index.

In some example embodiments, a network device comprises circuitry configured to: transmit, to the terminal device, a DCI scheduling multiple PDSCHs on multiple cells, one or more of the multiple PDSCHs being scheduled for a cell of the multiple cells; and receive, from the terminal device, a HARQ-ACK codebook for the multiple PDSCHs, the HARQ-ACK codebook comprising multiple bit groups corresponding to the multiple cells, where a first bit position in a first bit group for a first PDSCH on a first cell of the multiple cells is based on a reference bit position for a reference PDSCH on a reference cell in a reference bit group for the reference cell, the first PDSCH and the reference PDSCH having a same TDRA row index.

In some example embodiments, the first bit position is the same as the reference bit position. In some example embodiments, each of the multiple bit groups comprises a same number of bits, the number being determined based on a TDRA table of the reference cell.

In some example embodiments, the reference cell among the multiple cells is a cell with at least one of: a smallest number of bits for a corresponding bit group, a lowest index among cells with a same smallest number of bits for a corresponding bit group, or a highest index among cells with the same smallest number of bits for a corresponding bit group.

In some example embodiments, each of the multiple bit groups comprises a same number of bits equal to the smallest number of bits.

In some example embodiments, a network device comprises circuitry configured to: transmit, to the terminal device, a DCI scheduling multiple PDSCHs on multiple cells, one or more of the multiple PDSCHs being scheduled for a cell of the multiple cells; and receive, from the terminal device, a HARQ-ACK codebook for the multiple PDSCHs based on multiple subsets of slot offset values and multiple merged TDRA tables, wherein the multiple merged TDRA tables are determined based on the multiple subsets, and wherein each slot offset value is used to indicate a gap between a slot of one of the multiple PDSCHs and a slot of the HARQ-ACK codebook.

In some example embodiments, a network device comprises circuitry configured to: transmit, to the terminal device, a DCI scheduling multiple PDSCHs on multiple cells, one or more of the multiple PDSCHs being scheduled for a cell of the multiple cells; and receive, from the terminal device, a HARQ-ACK codebook for the multiple PDSCHs, the HARQ-ACK codebook comprising bits in an increasing order of PDSCH reception starting time of a reference cell.

In some example embodiments, the reference cell among the multiple cells is a cell with at least one of: a last slot of scheduled PDSCHs, a lowest index, or a highest index.

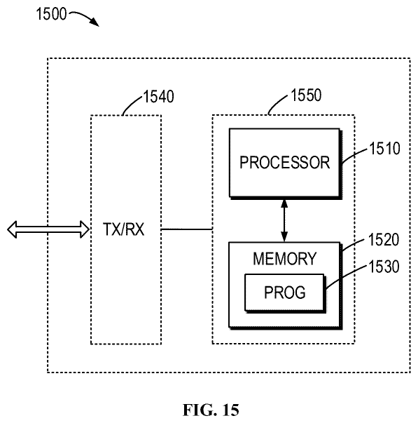

FIG. 15 illustrates a simplified block diagram of a device 1500 that is suitable for implementing embodiments of the present disclosure. The device 1500 can be considered as a further example implementation of the terminal device 120 and/or the network device 110 as shown in FIG. 1. Accordingly, the device 1500 can be implemented at or as at least a part of the terminal device 120 or the network device 110.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1530 is assumed to include program instructions that, when executed by the associated processor 1510, enable the device 1500 to operate in accordance with the embodiments of the present disclosure, as discussed herein with reference to FIGS. 3-14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device from a network device, downlink control information (DCI) scheduling a plurality of physical downlink shared channels (PDSCHs) on a plurality of cells, one or more of the plurality of PDSCHs being scheduled for a cell of the plurality of cells; determining, from the plurality of cells, a reference cell for generating a hybrid automatic repeat request (HARQ)-acknowledgement (ACK) codebook for the plurality of PDSCHs, the HARQ-ACK codebook comprising a plurality of bit groups corresponding to the plurality of cells; generating the HARQ-ACK codebook by determining, in a first bit group for a first cell of the plurality of cells, a first bit position for a first PDSCH on the first cell, based on a reference bit position for a reference PDSCH on the reference cell in a reference bit group for the reference cell, the first PDSCH and the reference PDSCH having a same time domain resource allocation (TDRA) row index; and transmitting the HARQ-ACK codebook to the network device.

In one embodiment, the method as above, the first bit position is the same as the reference bit position.

In one embodiment, the method as above, each of the plurality of bit groups comprises a same number of bits, the number being determined based on a TDRA table for the reference cell.

In one embodiment, the method as above, the reference cell among the plurality of cells is a cell with at least one of: a smallest number of bits for a corresponding bit group, a lowest index among cells with a same smallest number of bits for a corresponding bit group, or a highest index among cells with the same smallest number of bits for a corresponding bit group.

In one embodiment, the method as above, each of the plurality of bit groups comprises a same number of bits equal to the smallest number of bits.

The present disclosure provides a method of communication, comprises: receiving, at a terminal device from a network device, downlink control information (DCI) scheduling a plurality of physical downlink shared channels (PDSCHs) on a plurality of cells, one or more of the plurality of PDSCHs being scheduled for a cell of the plurality of cells; determining a plurality of subsets of slot offset values, each slot offset value indicating a gap between a slot of one of the plurality of PDSCHs and a slot of a hybrid automatic repeat request (HARQ)-acknowledgement (ACK) codebook; determining a plurality of merged time domain resource allocation (TDRA) tables based on the plurality of subsets; generating the HARQ-ACK codebook based on the plurality of subsets and the plurality of merged TDRA tables; and transmitting the HARQ-ACK codebook to the network device.

In one embodiment, the method as above, determining the plurality of merged TDRA tables comprises: determining a first subset of the plurality of subsets includes a plurality of slot offset values; and in accordance with a determination that a first set of slot offset values corresponding to a first TDRA table comprises one of the plurality of slot offset values and that a second set of slot offset values corresponding to a second TDRA table comprises another one of the plurality of slot offset values, generating a merged TDRA table of the plurality of merged TDRA tables by merging the first TDRA table and the second TDRA table.

In one embodiment, the method as above, determining the plurality of merged TDRA tables comprises: determining a second subset of the plurality of subsets includes one slot offset value; and in accordance with a determination that both a first set of slot offset values corresponding to a first TDRA table and a second set of slot offset values corresponding to a second TDRA table comprise the slot offset value, generating a merged TDRA table of the plurality of merged TDRA tables by merging the first TDRA table and the second TDRA table.

In one embodiment, the method as above, determining the plurality of subsets comprises: obtaining a slot offset value indicated by the DCI; determining a plurality of slot offset values corresponding to the plurality of cells, based on the slot offset value indicated by the DCI; and generating the plurality of subsets each comprising one of the plurality of slot offset values.

The present disclosure provides a method of communication, comprises: receiving, at a terminal device from a network device, downlink control information (DCI) scheduling a plurality of physical downlink shared channels (PDSCHs) on a plurality of cells, one or more of the plurality of PDSCHs being scheduled for a cell of the plurality of cells; determining, from the plurality of cells, a reference cell for generating a hybrid automatic repeat request (HARQ)-acknowledgement (ACK) codebook for the plurality of PDSCHs; generating the HARQ-ACK codebook comprising bits in an increasing order of a PDSCH reception starting time on the reference cell; and transmitting the HARQ-ACK codebook to the network device.

In one embodiment, the method as above, the reference cell among the plurality of cells is a cell with at least one of: a last slot of scheduled PDSCHs, a lowest index, or a highest index.

The present disclosure provides a method of communication, comprises: transmitting, at a network device to a terminal device, downlink control information (DCI) scheduling a plurality of physical downlink shared channels (PDSCHs) on a plurality of cells, one or more of the plurality of PDSCHs being scheduled for a cell of the plurality of cells; and receiving, from the terminal device, a hybrid automatic repeat request (HARQ) acknowledgement (ACK) codebook for the plurality of PDSCHs, the HARQ-ACK codebook comprising a plurality of bit groups corresponding to the plurality of cells, where a first bit position in a first bit group for a first PDSCH on a first cell of the plurality of cells is based on a reference bit position for a reference PDSCH on a reference cell in a reference bit group for the reference cell, the first PDSCH and the reference PDSCH having a same time domain resource allocation (TDRA) row index.

In one embodiment, the method as above, the first bit position is the same as the reference bit position.

In one embodiment, the method as above, each of the plurality of bit groups comprises a same number of bits, the number being determined based on a TDRA table of the reference cell.

In one embodiment, the method as above, the reference cell among the plurality of cells is a cell with at least one of: a smallest number of bits for a corresponding bit group, a lowest index among cells with a same smallest number of bits for a corresponding bit group, or a highest index among cells with the same smallest number of bits for a corresponding bit group.

In one embodiment, the method as above, each of the plurality of bit groups comprises a same number of bits equal to the smallest number of bits.

The present disclosure provides a method of communication, comprises: transmitting, at a network device to a terminal device, downlink control information (DCI) scheduling a plurality of physical downlink shared channels (PDSCHs) on a plurality of cells, one or more of the plurality of PDSCHs being scheduled for a cell of the plurality of cells; and receiving, from the terminal device, a hybrid automatic repeat request (HARQ) acknowledgement (ACK) codebook for the plurality of PDSCHs based on a plurality of subsets of slot offset values and a plurality of merged time domain resource allocation (TDRA) tables, wherein the plurality of merged TDRA tables are determined based on the plurality of subsets, and wherein each slot offset value is used to indicate a gap between a slot of one of the plurality of PDSCHs and a slot of the HARQ-ACK codebook.

The present disclosure provides a method of communication, comprises: transmitting, at a network device to a terminal device, downlink control information (DCI) scheduling a plurality of physical downlink shared channels (PDSCHs) on a plurality of cells, one or more of the plurality of PDSCHs being scheduled for a cell of the plurality of cells; receiving, from the terminal device, a hybrid automatic repeat request (HARQ)-acknowledgement (ACK) codebook for the plurality of PDSCHs, the HARQ-ACK codebook comprising bits in an increasing order of PDSCH reception starting time of a reference cell.

In one embodiment, the method as above, the reference cell among the plurality of cells is a cell with at least one of: a last slot of scheduled PDSCHs, a lowest index, or a highest index.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE), the method comprising:
receiving a Physical Downlink Control Channel (PDCCH) which provides a Downlink Control Information (DCI) format; and
generating a Hybrid Automatic repeat Request-Acknowledgement (HARQ-ACK) codebook for the DCI format,
wherein the DCI format is used to schedule one or more Physical Downlink Shared Channel (PDSCH) receptions in one or more serving cells, and
wherein the UE is configured to generate the HARQ-ACK codebook, in a case where the one or more PDSCH receptions are scheduled from a same PDCCH monitoring occasion, in increasing order of PDSCH reception starting time for a same pair of a reference cell and a PDCCH monitoring occasion.

22. The method according to claim 21,
wherein the reference cell is a serving cell with a smallest index from the one or more serving cells.

23. The method according to claim 21,
wherein the HARQ-ACK codebook is a Type-2 HARQ-ACK codebook.

24. The method according to claim 21,
wherein the UE is configured to generate the HARQ-ACK codebook based on a value of a Downlink Assignment Index (DAI), and
wherein the value of the DAI is included in the DCI format.

25. The method according to claim 21, further comprising:
transmitting a Physical Uplink Control Channel (PUCCH) with the HARQ-ACK codebook.

26. A User Equipment (UE) comprising:
a memory; and
a processor coupled with the memory, wherein the processor is configured to control the UE to:
receive a Physical Downlink Control Channel (PDCCH) which provides a Downlink Control Information (DCI) format, and
generate a Hybrid Automatic repeat Request-Acknowledgement (HARQ-ACK) codebook for the DCI format,
wherein the DCI format is used to schedule one or more Physical Downlink Shared Channel (PDSCH) receptions in one or more serving cells, and
wherein the UE is configured to generate the HARQ-ACK codebook, in a case where the one or more PDSCH receptions are scheduled from a same PDCCH monitoring occasion, in increasing order of PDSCH reception starting time for a same pair of a reference cell and a PDCCH monitoring occasion.

27. The UE according to claim 26,
wherein the reference cell is a serving cell with a smallest index from the one or more serving cells.

28. The UE according to claim 26,
wherein the HARQ-ACK codebook is a Type-2 HARQ-ACK codebook.

29. The UE according to claim 26,
wherein the UE is configured to generate the HARQ-ACK codebook based on a value of a Downlink Assignment Index (DAI), and
wherein the value of the DAI is included in the DCI format.

30. The UE according to claim 26,
wherein the processor is configured to control the UE to:
transmit a Physical Uplink Control Channel (PUCCH) with the HARQ-ACK codebook.
